(19) United States
(12) Patent Application Publication
(10) Pub. No.: US 2024/0052957 A1
(43) Pub. Date: Feb. 15, 2024

(54) NUT FOR TUBE CONNECTOR ASSEMBLY

(71) Applicant: SAINT-GOBAIN PERFORMANCE PLASTICS CORPORATION, Solon, OH (US)

(72) Inventors: Julien NALLET, Saint Didier D'Aussiat (FR); Stéphane DOMY, Chaumontel (FR); David R. COBB, Colleyville, TX (US)

(21) Appl. No.: 18/450,089

(22) Filed: Aug. 15, 2023

Related U.S. Application Data
(60) Provisional application No. 63/371,807, filed on Aug. 18, 2022.
(60) Provisional application No. 63/371,478, filed on Aug. 15, 2022.

(51) Int. Cl. F16L 19/02

(52) U.S. Cl. CPC F16L 19/0206; F16L 19/0237

(57) ABSTRACT

The present invention relates to a nut for a connector assembly for a tube including: an annular nut body including a polymer and oriented down a central axis, the annular nut body including: a circumferential split defining a first circumferential portion and a second circumferential portion, where the first circumferential portion and the second circumferential portion are flexibly connected by a pliable bridge portion, where the first circumferential portion includes a first circumferential end and the second circumferential portion includes a second circumferential end, where the first circumferential end and the second circumferential end each include a coupling component adapted to fix the first circumferential end and the second circumferential end together.

### CROSS-REFERENCE TO RELATED APPLICATION(S)

This application claims priority under 35 U.S.C. § 119(e) to U.S. Provisional Application No. 63/371,478, entitled “NUT FOR TUBE CONNECTOR ASSEMBLY,” by Julien NALLET et al., filed Aug. 15, 2022, and claims priority to U.S. Provisional Application No. 63/371,807, entitled “NUT FOR TUBE CONNECTOR ASSEMBLY,” by Julien NALLET et al., filed Aug. 18, 2022, all of which are assigned to the current assignee hereof and incorporated herein by reference in their entireties.

### FIELD OF THE INVENTION

The present disclosure relates to a nut for a tube fitting coupling assembly for connecting at least one tube to another component of a fluid transport circuit such as a connector, a pump, a valve, a manifold, etc. suitable for, but not limited to, use in a corrosive and/or high purity fluid transport circuit.

### BACKGROUND

In connection with the field of corrosive fluids transport, coupling assemblies are already known for connecting a tube to a body part of another component. Often these coupling assemblies include a ring part mounted on the periphery of the tube and receiving at one end a curved end portion of the tube, and where the sealing is achieved by axially clamping the curved end portion of the tube against a receiving surface through said ring. In some embodiments, the ring is overlaid by a nut for further containment of the tube; however, this nut is sometimes inadequate in sealing, size, and interchangeability. Therefore, there continues to be a need for improved coupling assemblies.

### BRIEF DESCRIPTION OF THE DRAWINGS

The present disclosure will be well understood and its advantages will appear more clearly from the following detailed description of an embodiment, shown by way of non-limiting example. The description refers to the accompanying drawings in which:

FIG. 1 is a perspective view of an example connector assembly for a tube according to a number of embodiments;

FIG. 2 is an example section according to II of FIG. 1;

FIG. 3 is a view of the detail III of FIG. 2;

FIG. 4 is an example section according to IV of FIG. 1;

FIG. 5 is a view of the detail V of FIG. 4;

FIG. 6 is an example section according to II of FIG. 1.

FIG. 7 is a cross sectional view of another example connector assembly for a tube according to a number of embodiments;

FIG. 8 is a side view of a nut for an example connector assembly for a tube according to a number of embodiments;

FIG. 9A is a cross-sectional view of a nut within an example connector assembly for a tube according to a number of embodiments;

FIG. 9B is a cross-sectional view of a nut within an example connector assembly for a tube according to a number of embodiments;

FIG. 9C is a cross-sectional view of a nut within an example connector assembly for a tube according to a number of embodiments;

FIG. 9D is a cross-sectional view of a nut within an example connector assembly for a tube according to a number of embodiments;

FIG. 9E is a cross-sectional view of a nut within an example connector assembly for a tube according to a number of embodiments;

FIG. 9F is a cross-sectional view of a nut within an example connector assembly for a tube according to a number of embodiments;

FIG. 9G is a cross-sectional view of a nut within an example connector assembly for a tube according to a number of embodiments;

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the tube connector assembly arts.

Embodiments described herein are generally directed to a nut for a connector assembly for a tube including: an annular nut body including a polymer and oriented down a central axis, the annular nut body including: a circumferential split defining a first circumferential portion and a second circumferential portion, where the first circumferential portion and the second circumferential portion are flexibly connected by a pliable bridge portion, where the first circumferential portion includes a first circumferential end and the second circumferential portion includes a second circumferential end, where the first circumferential end and the second circumferential end each include a coupling component adapted to fix the first circumferential end and the second circumferential end together.

Embodiments described herein are generally directed to a nut for a connector assembly for a tube including: an annular nut body oriented down a central axis, the annular nut body having a cross-section taken along the central axis including: an axially projecting portion including exterior threadings and an end portion; and a radially projecting portion disposed axially adjacent to the axially projecting portion, where the radially projecting portion includes a first flange projecting radially inward, where at least one of the first flange or the end portion is adapted to seal against a neighboring component, and where the annular nut body further includes a circumferential split.

Embodiments described herein are generally directed to a connector assembly for a tube including: a body provided with a cavity extending in an axial direction, a ring adapted to be mounted at the periphery of a useful portion of the tube, the ring having at one end a support surface adapted to receive a curved end portion of the tube, and a nut adapted to be screwed onto the body so as to engage the ring to press the curved end portion of the tube against a receiving surface in the axial direction, and an annular receiving part forming the receiving surface and removably mounted on the body, where the nut includes: an annular nut body and oriented down a central axis, the annular nut body having a cross-section taken along the central axis including: an axially projecting portion including external threadings and an end portion; and a radially projecting portion disposed axially adjacent to the axially projecting portion, where at least one of 1) the radially projecting portion includes a first flange projecting radially inward, where at least one of the first flange or the end portion is adapted to seal against receiving part, or 2) where the annular nut body includes a polymer and further includes a circumferential split.

Embodiments described herein are generally directed to a connector assembly for a tube including: a body provided with a cavity extending in an axial direction, an annular receiving part forming a receiving surface and removably mounted on the body, and a nut adapted to be screwed onto the body so as to engage the annular receiving part to press the tube against the receiving surface in the axial direction, where the nut includes: an annular nut body and oriented down a central axis, the annular nut body having a cross-section taken along the central axis including: an axially projecting portion including external threadings and an end portion; and a radially projecting portion disposed axially adjacent to the axially projecting portion, where at least one of 1) the radially projecting portion includes a first flange projecting radially inward, where at least one of the first flange or the end portion is adapted to seal against receiving part, or 2) where the annular nut body includes a polymer and further includes a circumferential split.

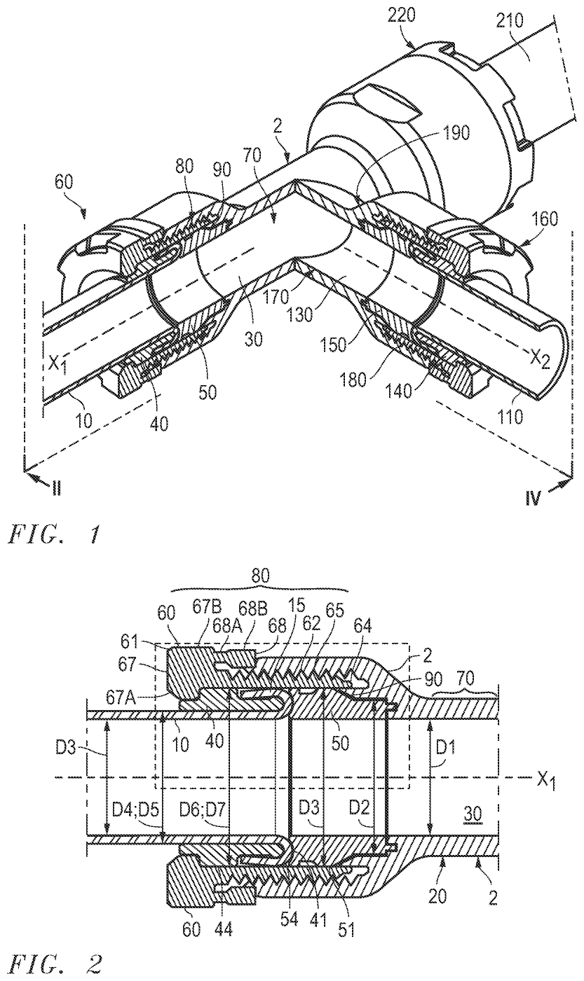

FIG. 1 shows a connector assembly 1 according to an embodiment. As shown in FIG. 1, the connector assembly 1 according to certain embodiments may be for connecting one or more tubes 10, 110, 210 to another component of the same fluid transport circuit, which may include the body 2. The term “fluid transport circuit” here is understood to mean a set of connected conduits that can be traversed by the fluid. In a number of embodiments, the body 2 may be, for example, a pump, a valve, a fitting, a stopper, a manifold, a coupling, in particular a T, an I, an L or a U-coupling, or a plug. The connector assembly 1 may be used for connecting, on a body 2 forming a T-connection with three branches, 20, 120, 220, of three tubes 10, 110, 210. The body 2 may be provided with a through cavity extending in an axial direction. Thereafter, the adjective “axial” and the adverb “axially” are used with reference to the direction of the axis of the cavity in question. With reference to the same cavity, a radial direction is defined as a direction orthogonal to the axis of the cavity and passing through this axis. The body 2 may include at least one through cavity to which the tube 10, 110, 210 can be connected. It may be formed from a single monolithic part or from several parts, suitably fastened together. At least a portion of this cavity may form part of the fluid transport circuit in the extension of the tube.

Still referring to FIG. 1, the connector assembly 1 includes, at the first branch 20, a body part defining a through cylindrical cavity 30 of a central axis X1, a ring 40 adapted to be mounted at the periphery of a useful portion of the tube 10 and provided, at one of its ends, with a support surface 41 adapted to receive a curved end portion of the tube 15, an annular receiving part 50 removably mounted in the cavity 30 of the body 2, and defining a receiving surface 54 for the curved end portion 15 of the tube 10, and a nut 60 adapted to cooperate with the ring 40 and to be screwed onto the body 2 so as to compress the curved end portion 15 of the tube 10 against the receiving surface 54 of the receiving part 50, in the axial direction, by means of the ring 40. In an embodiment, the connector assembly may further include a tube 10, 110, 210, one end portion of which may be bent back against the support surface of the ring 40. When the connector assembly 1 is in the mounted position, the ring 40, the nut 60, and at least a useful portion of the tube 10 may extend along the axial direction of the body 2 cavity on which they are mounted.

Still referring to FIG. 1, the ring 40 can be adapted to be mounted at the periphery of a useful portion of the tube 10, 110, 210 and to receive, at one of its axial ends, a curved portion of the tube 10, 110, 210. “Useful portion of the tube” means here a portion of the tube 10, 110, 210 forming part of the fluid transport circuit and therefore adapted to the actual transport of fluid. The curved portion of the tube 10, 110, 210 may be designed to be compressed axially against a receiving surface, in order to seal the system. According to described embodiments, the receiving surface may be formed by an annular receiving part 50, distinct from the body 2, and mounted thereon in a removable manner. When the nut 60 is screwed onto the body 2, the curved end portion of the tube 10, 110, 210 can thus be compressed against the receiving part 50 in the axial direction via the ring 40. The curved portion of the tube 10, 110, 210, once clamped between the ring 40 and the receiving part 50, forms a sealing joint between the tube 10, 110, 210 and the said receiving part 50. Since the receiving part 50 may be removable, the receiving surface can be changed to adapt to different tube 10, 110, 210 diameters and therefore corresponding rings 40, the body 2 being able to remain unchanged. The connector assembly, according to the described embodiments, may be modular according to the needs of the user, which can change during the life of the body in question. For example, if the body is a pump, the connector assembly, according to described embodiments, connects tubes of different diameters to said pump, without having to modify the latter.

Still referring to FIG. 1, the cavity 30, which communicates with other cavities of the body 2 and, in particular, with the through cavities of the second and third branches 120, 220, includes at least one main section 70 of diameter D1 and a widened end section 80, of diameter D2 greater than D1 (see FIG. 2). The end section 80 opens outwards at its rear end 80b, and may be connected to the main section at its front end 80a by a shoulder 90. As illustrated in FIG. 3, the shoulder 90 here includes a first generally frustoconical part 92 connected to the enlarged end section 80, and a second part 93 extending radially (orthogonally to the axis X1) connected to the main section 70. Throughout the remainder of the present disclosure, the terms “front” and “rear” will be used with reference to the axial direction, the mounting of the ring 40 and the nut 60 through the rear end of the through cavity 30 being made towards the front (towards the body).

FIG. 2 is an example section according to II of FIG. 1. FIG. 3 is a view of the detail III of FIG. 2. As illustrated in FIGS. 2 and 3, the widened end section 80 of the cavity may be provided, at its rear end 80b, with an internal thread 81 whose function will be specified hereinafter. As illustrated best in FIG. 2, the ring 40 forms a tubular sleeve, the axis of which, in the mounted position, coincides with the axis X1 of the cavity 30 of the body 2. The ring 40 may surround a useful portion 14 of the tube where said tube 10 is cylindrical, of internal diameter D3 and of external diameter D4 (see FIG. 2). To enable it to be mounted on the tube 10, the ring 40 has an internal diameter D5 substantially equal to or slightly greater than the external diameter D4 of the tube 10. The front end 40a of the ring 40, directed towards the body 2 in the mounted position, forms a support surface 41 adapted to receive the curved end portion 15 of the tube 10. In an embodiment, the front end 40a of the ring 40, directed towards the body 2 in the mounted position, forms a support surface 41 adapted to receive only the curved end portion 15 of the tube 10. In the embodiment (see in particular FIG. 3), the axial end 40a of the ring 40 may be rounded, the support surface 41 having, in particular, an axial semi-circular cross-section with a radius of curvature r1 equal to half the thickness e4 of the ring. According to variants (not shown), the end 40a of the ring 40 may have any other suitable shape. It may, for example, have an axial section in the form of a point with a rounded end, with a radius less than e4/2. In an embodiment, the end portion 15 of the tube 10 may be curved around the support surface 41 so that an axial end surface 15a of the said curved portion 15 has a semicircular axial section with a radius of curvature r2 equal to the radius of curvature r1 of the support surface 41 of the ring 40, with the added thickness of the tube 10.

Still referring to FIGS. 2 and 3, the nut 60 may be a separate part from the ring 40, configured to be mounted at the periphery of the ring 40 and provided with threadings 61, external in this case, adapted to cooperate by screwing with the internal thread 81 of the body 2. As illustrated in the Figures, the nut 60 may not be in contact with the tube 10. More particularly, the nut 60 may be adapted to be engaged on the ring 40 through the rear end 40b of the latter, opposite to the support surface 41. It will be understood that during the mounting of the assembly 1, the nut 60 may be engaged on the tube 10 before the ring 40, or at the same time as the latter.

As shown best in FIG. 2, to enable mounting of the nut 60, the ring 40 has at least one mounting section 42 extending from the rear end 40b, having an external diameter D6 substantially equal to, or smaller than the internal diameter D7 of the nut 6. At least one part 43 (in the embodiment, the entire length) of said section 42 has an external diameter substantially equal to the internal diameter of the nut 60. At the same time, and as indicated above, the nut 60 may be adapted to cooperate with the ring 40 in order to move the latter integrally in the axial direction X. The ring 40 may be, for this purpose, provided with abutment means with which the nut 60 may be adapted to cooperate axially in order to integrally displace said ring 40 in the axial direction. These abutment means include, in the embodiment, an annular and continuous circumferential rib 44 formed at the periphery of the ring 40, near the front end 40a of said ring 40 carrying the support surface 41. According to an embodiment, the rib 44 may be dimensioned to bear radially against the internal surface of the body 2, in the mounted position, enabling a prepositioning of the ring before mounting the nut.

Still referring to FIGS. 2 and 3, the removable receiving part 50, which has an annular shape, may be mounted inside the cavity 30 of the body 2. The receiving part 50 may be configured here to cooperate positively with the body 2. For this purpose, and as illustrated in FIG. 2, the receiving part 50 includes a cylindrical radially outer surface 51 of diameter D8 substantially identical to the diameter D2 of the widened end section 80, which ensures its blocking with respect to the body 2 in the radial direction. As shown in FIG. 3, the receiving part 50 further includes a front surface 52, directed towards the interior of the body 2, shaped to bear, at least in part, on the shoulder 90.

As shown in FIGS. 2 and 3, the sealing between the receiving part 50 and the body 2 may be achieved here by the cooperation of an annular rib 53 projecting from the front surface 52 of the receiving part and a groove 91 formed in the surface of the second part 93 of the shoulder 90. According to yet another embodiment, the receiving part 50 or the body 2 may be provided with at least one male element and the other, either the receiving part or the body, may be provided with a female element adapted to cooperate by clamping with the male element to achieve sealing between the two parts. For example, as shown best in FIG. 2, the receiving part 50 may be provided with an annular rib 53 and the body 2 may be provided with a groove 91, the rib 53 being adapted to clamp radially and axially in said groove 91 to ensure sealing. According to another embodiment, the sealing means may include a seal, in particular an O-ring, which can be placed between the receiving part 50 and the body 2. According to another embodiment, the cavity of the body 2 may include a main section and a widened end section opening outwards. The body 2 may then have a shoulder at the junction between the main section and the end section. In this case, the sealing means can provide sealing between the receiving part 50 and said shoulder of the body 2. According to yet another embodiment, the receiving part 50 may be adapted to be mounted inside the body 2 bearing against the shoulder, in particular on the part of said shoulder carrying sealing means, if necessary. According to another particular embodiment, the body 2 and the receiving part 50 may be configured to cooperate positively in order to lock the receiving part relative to the body 2, in the radial direction.

This sealing system allows at the same time to avoid any radial deformation of the receiving part 50 which can lead to the formation of retention zones disturbing the flow of the fluid. As an alternative, the sealing between the receiving part and the body could be achieved by any other suitable system, for example, by a gasket partly compressed in at least one groove formed in one of the receiving part and the body, and another part which could be compressed against the other of the receiving part and the body.

Still referring to FIGS. 2 and 3, as previously indicated, the receiving part 50 therefore bears against part of the shoulder 90, and more particularly against the second part 93 of the shoulder which includes the groove 91 and which may also be directly opposite the shoulder zone of the receiving surface for receiving the curved portion of the tube. In this way, the body 2 and the receiving part 50 may be configured to cooperate positively in order to lock the receiving part relative to the body 2, in the radial direction. The receiving part 50 further includes a rear surface 54 directed towards the open end of the cavity 30 forming the receiving surface on which the curved end portion 15 of the tube 10 can be clamped under the effect of the screwing of the nut 60 on the body 2. The receiving part 50 further includes a rear surface 54, directed towards the open end of the cavity 30 forming the receiving surface on which the curved end portion 15 of the tube 10 can be clamped upon screwing of the nut 60 on the body 2.

As illustrated best in FIG. 3, the receiving surface 54 may include an annular groove 55, in particular a groove with a curved axial cross-section, configured to cooperate positively with the compressed end portion 15 of the tube 10. In the embodiment illustrated in FIG. 3, the groove 55 has at least one section in a semi-circle having a radius of curvature r2.

Finally, the receiving part 50 includes a useful radially internal surface (hereinafter the useful surface) 56 intended to make the junction between the useful portion 14 of the tube 10 and the main section 70 of the cavity 30. In other words, as illustrated in FIG. 3, a rear end 56b of said useful surface may be in contact or flush with the internal surface of the useful portion 15 of the tube 10, and a front end 56a of said useful surface 56 may be in contact or flush with the internal surface of the main section 70. It will be understood that the receiving part 50 may then delimit, with its useful internal surface, a portion of the fluid circulation circuit. In this case, the receiving part 50 may be preferably shaped so that the junction between the main section of the cavity and the useful portion of the tube 10, 110, 210 may be progressive (without sudden break), in order to avoid the creation of recesses, and therefore retention areas, which can disrupt the fluid flow.

In an embodiment, the internal diameter D3 of the tube 10 and the diameter D1 of the main section 70 of the cavity 30 of the body may be substantially identical. The useful surface 56 may be thus exactly aligned with the internal surface of the tube 10 and the internal surface of the cavity 30, the three elements forming a cylindrical conduit of constant diameter. In a case where the internal diameter of the tube 10 and the diameter of the main section of the cavity of the body 2 may be substantially identical, the effective internal surface of the receiving part 50 may be cylindrical, the diameter of which may be substantially equal to the internal diameter of the main section. According to another embodiment, when the internal diameter of the tube 10 and the diameter of the main section of the body 2 cavity may be different, the effective internal surface of the receiving part 50 can expand over at least a part of its axial length. For example, the effective internal surface may, on at least one axial section, have a generally frustoconical shape.

In order to further improve the sealing between the tube 10 and the receiving part 50, the latter may have an annular groove, in particular a groove with a curved axial cross-section, configured to cooperate positively with the compressed end portion of the tube 10. The positive fit between the receiving surface 50 and the curved portion of the tube 10 increases the contact area between the two parts and thus reduces the risk of leakage.

Still referring to FIGS. 2 and 3, according to another embodiment, the nut 60 may be configured to be screwed inside the body 2 cavity. Such a configuration allows increasing the compactness of the connector assembly. Moreover, the mechanical stresses in the nut may be reduced, the applied forces being in alignment with the axial clamping forces of the curved portion of the tube 10 on the receiving part 50. According to another embodiment, the nut 60 may be formed integrally with the ring 40, or, on the contrary, it may be distinct from the ring 40. In the latter case, the nut 60 may be adapted to cooperate with the ring 40 so as to drive it integrally in the axial direction. According to another embodiment, the nut 60 may not be in contact with the tube 10. Thus, the tube 10 may not be damaged when screwing the nut 60. According to another particular embodiment, the nut 60 may be configured to be mounted on the periphery of the ring 40, and the ring 40 may be provided with abutment means with which the nut 60 may be adapted to cooperate in order to integrally displace said ring 40 in the axial direction. The nut 60 being mounted on the periphery of the ring 40, it may be possible to use a same nut with rings 40 of different internal diameters, adapted to tubes 10 of different diameters. Thanks to these arrangements, it may be thus possible to combine, with a single body 2 and a single nut 60, several rings and possibly several different reception parts, in order to adapt the system to tubes of different diameters. The abutment means may include, for example, a rib formed at the periphery of the ring 40, in particular a rib extending over the entire circumference of the ring 40.

Still referring to FIGS. 2 and 3, the nut 60 may include an annular nut body 61 oriented down the central axis X1. The annular nut body 61 may include an axially projecting portion 65 and a radially projecting portion 67 disposed axially adjacent to the axially projecting 65 portion. The axially projecting portion 65 may include an engagement portion 62 an end portion 64. The engagement portion 62 may include threadings which may include exterior threadings or interior threadings. As shown in FIGS. 2 and 3, the threadings 62 may be exterior threadings. The threadings 62 may be adapted to engage with a complementary engagement portion (e.g. threadings) within the body 2. This engagement may fix and/or lock the nut 60 and the body 2 together. In a number of embodiments, the end portion 64 may provide a seal against a neighboring component (e.g. the body 2). The end portion 64 may have an arcuate cross-section. The end portion 64 may have an arcuate cross-section.

Still referring to FIGS. 2 and 3, the radially projecting portion 67 may include a first flange 67A projecting radially inward. The radially projecting portion 67 may include a second flange 67B projecting radially outward. In a number of embodiments, the first flange 67A may provide a seal against a neighboring component (e.g. ring 40). As a result of the seal provided by at least one of the first flange 67A or the first end portion 64, the nut provides a leakage rate of as between 100-500 cc/min via the sealing of at least one of the first flange 67A against the ring 40 or the end portion 64 against body 3. The first flange 67A may have a rectilinear cross-section. The first flange 67A may have an arcuate cross-section. The second flange 67B may have a rectilinear cross-section. The second flange 67B may have an arcuate cross-section. Further, as shown in FIG. 3, the first flange 67A of the nut 60 may include a bead 66 that provides the seal against a neighboring groove 46 of the ring 40. Alternatively, the bead may be located on the ring 40 while the groove may be located on the nut 60. As a result, there may be multiple locations of sealings within the connector assembly 1. The first may be radially tightening of the annular rib 53 of receiving part 50 into the groove 91 of body 2. The second may be the axial tightening by pinching the tube 10 between ring 40 and receiving part 50. The third may be the radial tightening of nut 60 on body 2. The fourth may be the axial tightening of nut 60 on ring 40.

Still referring to FIGS. 2 and 3, in a number of embodiments, the second flange 67B may include an axially oriented tab 68 disposed radially and adapted to lock the nut against a neighboring component (e.g. body 2). The axially oriented tab 68 may have a rectilinear cross-section. The axially oriented tab 68 may have an arcuate cross-section. In a number of embodiments, the axially oriented tab 68 may include a bridge portion 68A and a head portion 68B. The structure and dimensions of the nut 60 may be described in further detail below.

As will be explained hereinafter, the connector assembly 1 according to the described embodiments allows connecting tubes of different diameters to the same cavity 30 of the body 2. To do this, it suffices to adapt the receiving part 50 and the ring 40 to the diameter of the tube to be connected. In the example of FIG. 1, the cylindrical cavity 130 of the second branch 120 of the body 2 has the same structure and dimensions as the cavity 30 described above. However, the tube 110 connected to this second cavity has a smaller diameter than that of the tube 10. In particular, the internal diameter D3′ of the tube 110 may be smaller than the internal diameter D1 of the main section of the cavity 130.

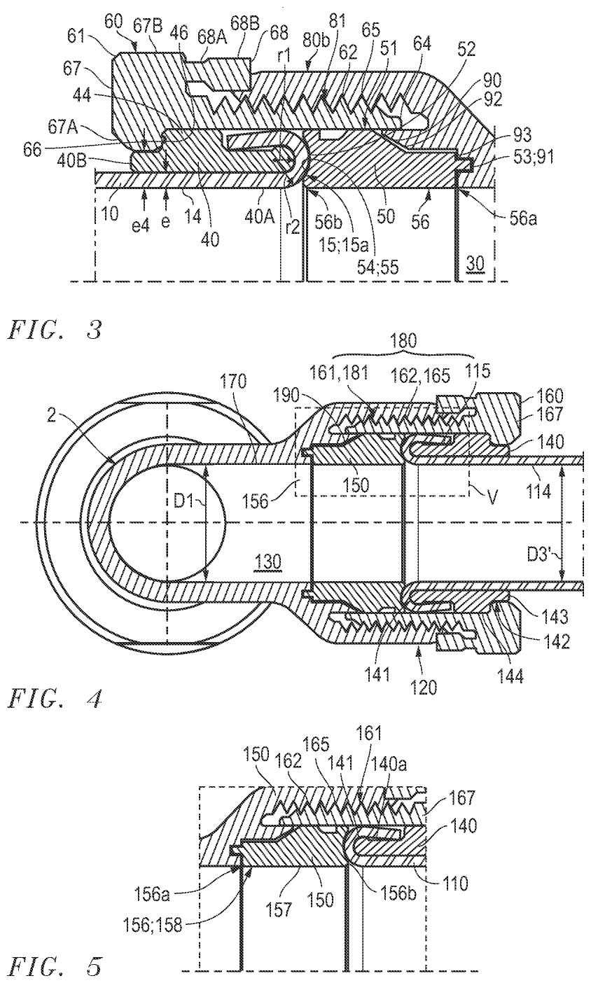

FIG. 4 is an example section according to IV of FIG. 1. In other words, FIG. 4 illustrates in more detail the connection of the tube 110 according to a number of embodiments. FIG. 5 is a view of the detail V of FIG. 4. In these Figures, the elements identical or similar to those described in connection with FIGS. 2 and 3 are designated by the same reference number incremented by 100, and are not described again thereafter.

As shown in FIG. 4, the ring 140 may be mounted at the periphery of a useful portion 114 of the tube 110. Its internal diameter may be substantially equal to, or slightly greater than the external diameter of the tube 110. As in the previous embodiment, the nut 160, identical to the nut 60 described above, may be adapted to be mounted on a mounting section 142 of the ring 140. To save the material of the ring on the one hand, and limit the friction between the ring 140 and the nut 160 on the other hand, only a portion 143 of the said mounting section 142 has an external diameter substantially equal to the internal diameter of the nut so that the nut 160 can bear on it. Likewise, as in the preceding example, the receiving part 150 has a useful internal surface 156 intended to make the junction between the useful portion 114 of the tube 110 and the main section 170 of the cavity 130.

In the example, due to the difference in diameter between the tube 110 and the main section 170 of the cavity 130, the useful surface 156 flares over at least a part of its axial length, particularly towards the front. In other words, the useful surface 156 has a spacing c with the axis X which increases from its rear end 156b or a point between said rear end 156b and its front end 156a, towards its front end 156a.

In the example of FIGS. 4 and 5, more particularly, the useful surface 156 includes a first cylindrical portion 157 extending from its rear end 156b connected to the internal surface of the tube 110, and a second portion 158, located directly in the extension of said first portion 157, of flared shape, generally frustoconical. According to other variants, the useful surface 156 may also include a flared portion of a different shape, for example the useful surface 156 may include a flared portion with a curved profile. It should be noted that if the diameter of the tube to be connected was, unlike in the previous description, larger than the diameter of the main section of the cavity, the receiving part could also be configured so that the useful internal surface of said receiving part flares towards the rear.

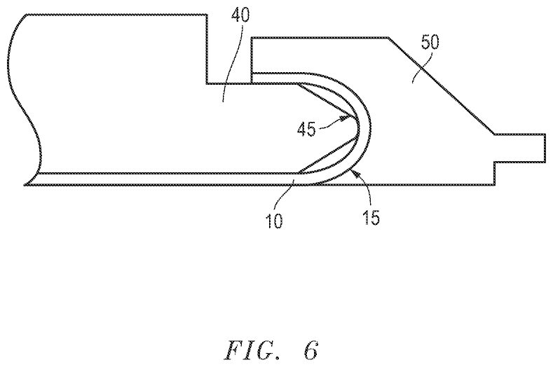

FIG. 6 is an example section according to II of FIG. 1. In this Figure, the elements identical or similar to those described in connection with FIGS. 2 and 3 are designated by the same reference number, and are not described again thereafter.

As shown in FIG. 6, alternate configurations for the ring (40) may provide improved performance in particular circumstances. For example, FIG. 6 shows the interface of a ring (40) with a curved end portion (15) of a tube (10). The ring (40) may have a beveled or chamfered surface (45) at the interface with the curved end portion (15) of the tube (10). Consequently, the ring (40) may only partially contact the curved end portion (15) of the tube (10) such that the ring (40) may not be in contact with the curved end portion (15) of the tube (10) over the entire surface of the curved end portion (15) of the tube (10) at the interface. This feature may provide a better seal while reducing damage to the tube (10), which may result in improved sealing performance of the connector assembly and enhanced durability of the tube (10). While FIG. 6 shows the ring (40), this design may also be used in the ring (140) of FIG. 4 and FIG. 5. Thus, the connector assembly described above allows connecting, on through cavities of same dimensions, pipes of different diameters by simply changing the receiving part and the ring on which the tube is turned, while the nut can be retained for use with these different tubes.

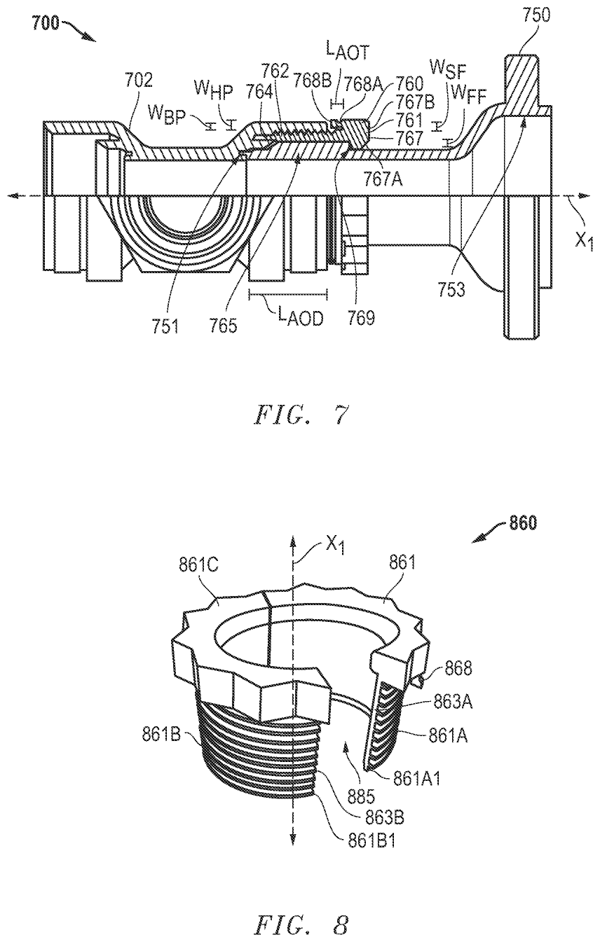

FIG. 7 is a perspective view of another example connector assembly for a tube according to one embodiment. In this Figure, the elements identical or similar to those described in connection with FIGS. 2 and 3 are designated by the same reference number incremented by 700, and are not described again thereafter. FIG. 7 illustrates a cross-section of the connector assembly (including the nut) taken along the central axis, X1. As shown in FIG. 7, the body 702 may connect with a receiving part 750 and be held in place by a nut 760 down a central axis, X1. The nut 760 may include an annular nut body 761 oriented down the central axis X1. The annular nut body 761 may include an axially projecting portion 765 and a radially projecting portion 767 disposed axially adjacent to the axially projecting 765 portion. The axially projecting portion 765 may include an engagement portion 762 and an end portion 764. The engagement portion 762 may include threadings which may include exterior threadings or interior threadings. As shown in FIG. 7, the threadings 762 may be exterior threadings. The threadings 762 may be adapted to engage with a complementary engagement portion (e.g. threadings) within the body 702. This engagement may fix and/or lock the nut 760 and the body 702 together. In a number of embodiments, the end portion 764 may provide a seal against a neighboring component (e.g. the body 702). The end portion 764 may have an arcuate cross-section.

Still referring to FIG. 7, the radially projecting portion 767 may include a first flange 767A projecting radially inward. The radially projecting portion 767 may include a second flange 767B projecting radially outward. In a number of embodiments, the first flange 767A may provide a seal against a neighboring component (e.g. receiving part 750). As a result of the seal provided by at least one of the first flange 767A or the first end portion 764, the nut provides a leakage rate of as between 100-500 cc/min via the sealing of at least one of the first flange 767A against the receiving part 750 or the end portion 764 against the body 702. The first flange 767A may have a rectilinear cross-section. The first flange 767A may have an arcuate cross-section. The second flange 767B may have a rectilinear cross-section. The second flange 767B may have an arcuate cross-section. In a number of embodiments, first flange 767A may have a width, W_{FF}, and the second flange 767B may have a width, W_{SF}, and wherein W_{SF}>W_{FF}, such as W_{SF}>1.5 W_{FF}, such as W_{SF}>2 W_{FF}, such as W_{SF}>3 W_{FF}, or such as W_{SF}>5 W_{FF}. In a number of embodiments, as shown below, the second flange 767B may have a width, W_{SF}, that varies around a circumference of the annular nut body 761.

In a number of embodiments, the receiving part 750 may include a first engaging portion 751 adapted to seal the body 702 to the receiving part 750. In a number of embodiments, the receiving part 750 may include a second engaging portion 769 adapted to seal the nut 760 to the receiving part 750. In a number of embodiments, the receiving part 750 may include a third engaging portion 753 adapted to seal against a neighboring component to the receiving part 750. There are variable structures of the third engaging portion 753 as illustrated below.

In a number of embodiments, the second flange 767B may include an axially oriented tab 768 disposed radially and adapted to lock the nut against a neighboring component (e.g. body 702). The axially oriented tab 768 may have a rectilinear cross-section. The axially oriented tab 768 may have an arcuate cross-section. The axially oriented tab may have a length, L_{AOT}, and the axially projecting portion has a length, L_{APP}, where L_{APP}>L_{AOT}, such as L_{APP}>1.5 L_{AOT}, such as L_{APP}>2 L_{AOT}, such as L_{APP}>3 L_{AOT}, or such as L_{APP}>5 L_{AOT}. In a number of embodiments, the axially oriented tab 768 may include a bridge portion 768A and a head portion 768B. In a number of embodiments, the bridge portion 768A has a width, W_{BP}, and the head portion 768B has a width, W_{HP}, where W_{HP}>W_{BP}, such as W_{HP}>1.5 W_{BP}, such as W_{HP}>2 W_{BP}, such as W_{HP}>3 W_{BP}, or such as W_{HP}>5 W_{BP}. The annular structure of the nut 760 may be described in further detail below.

FIG. 8 is a side view of a nut for an example connector assembly for a tube according to a number of embodiments. In this Figure, the elements identical or similar to those described in connection with FIGS. 2-7 are designated by the same reference number incremented by 800, and are not described again thereafter. The nut 860 may include an annular nut body 861 oriented down a central axis X1. The annular nut body 861 may include at least one circumferential split 885 defining a first circumferential portion 861A and a second circumferential portion 861B. In a number of embodiments, the circumferential split may be parallel to the central axis, X1. In a number of embodiments, the circumferential split may be diagonal along the central axis, X1. In a number of embodiments, the circumferential split may be a zig-zag shape along the central axis, X1. In a number of embodiments, the first circumferential portion 861A and the second circumferential portion 861B may be flexibly connected by a pliable bridge portion 861C. The bridge portion 861C may allow for bending of the first circumferential portion 861A relative to the second circumferential portion 861B, or vice versa. In an embodiment, the bridge portion 861C may allow for elastic bending of the first circumferential portion 861A relative to the second circumferential portion 861B, or vice versa. Alternatively, the bridge portion 861C may be replaced by a second split, separating the first circumferential portion 861A and the second circumferential portion 861B.

Still referring to FIG. 8, the first circumferential portion 861A may include a first circumferential end 861A1 and the second circumferential portion 861B may include a second circumferential end 861B1 defining the circumferential split 885. In a number of embodiments, the first circumferential end 861A1 and the second circumferential end 861B1 may each include a coupling component 863A, 863B adapted to fix the first circumferential end 861A1 and the second circumferential end 861B1 together. The coupling components 863A, 863B may include at least one of at least one of nuts, bolts, bearings, battens, buckles, clips, flanges, frogs, grommets, hook-and-eyes, latches, pegs, nails, rivets, tongue-and grooves, screw anchors, snap fasteners, stitches, threaded fasteners, ties, toggle bolts, wedges anchors, screws, bolts, clamps, clasps, clips, latches, pins, rivets, ties, nails, or may be another type. The circumferential split 885 (along with the bridge portion 861C) allows for the nut 860 to be easily coupled over the connector assembly described herein. Further, the circumferential split 885 allows for retrofitting the nut 860 over existing connector assemblies having tubes of different diameters and sizes while maintaining sealing of the connector assembly.

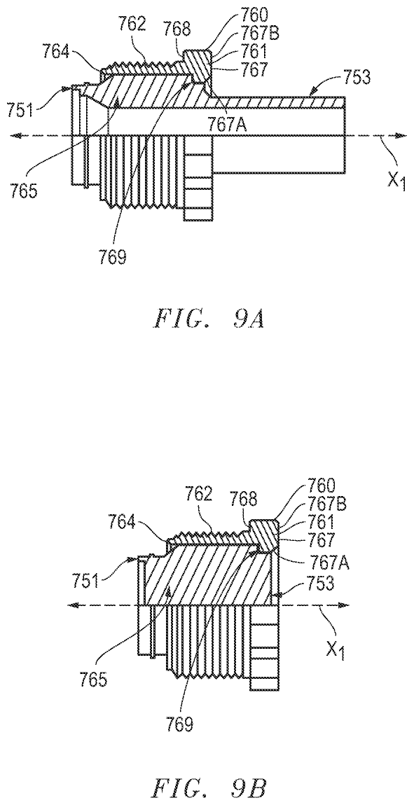

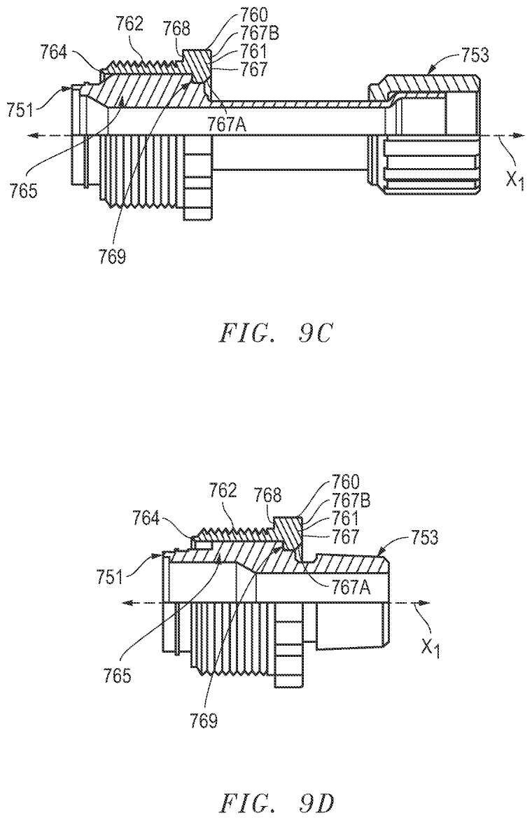

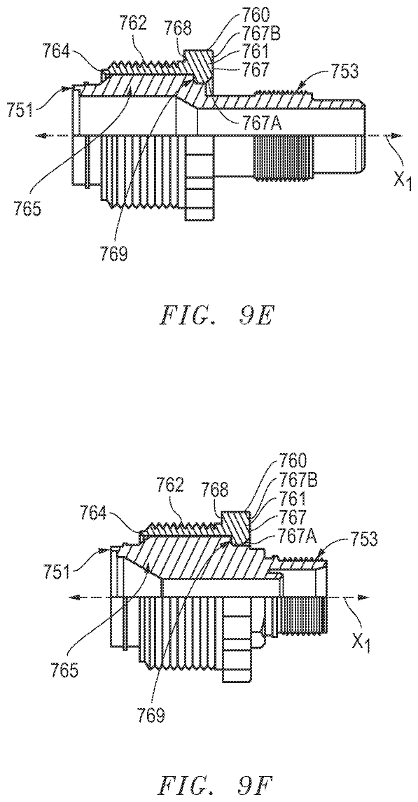

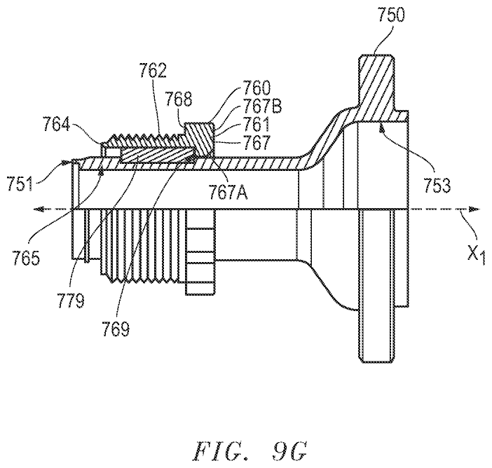

FIGS. 9A-9G illustrate side views of a nut within an example connector assembly for a tube according to a number of embodiments. FIG. 9A illustrates a fusebond connection between the nut 760 and the receiving part 750. FIG. 9B illustrates a male cap connection between the nut 760 and the receiving part 750. FIG. 9C illustrates a female flare connection between the nut 760 and the receiving part 750. FIG. 9D illustrates a male NPT connection between the nut 760 and the receiving part 750. FIG. 9E illustrates a male flare connection between the nut 760 and the receiving part 750. FIG. 9F illustrates a third party connection between the nut 760 and the receiving part 750. FIG. 9G illustrates an additional insert connection 779 between the nut 760 and the receiving part 750. As shown in FIGS. 9A-9G, the third engaging portion 753 may have variable shapes for the desired application. It is contemplated herein that when the diameter of the third engaging portion 753 is larger than the inner diameter of the nut 760, a split nut 760 may be required.

According to one embodiment, the body 2 and/or the receiving part 50, and/or the tube 10, 110, 210, and/or the ring 40, and/or the nut 60, may be made of a plastic material. According to one embodiment, at least one of these elements is, for example, made of a fluoropolymer. According to another embodiment, each of these elements is, for example, a fluoropolymer. In the context of the described embodiments, the term “fluoropolymer” refers to any polymer having in its chain at least one monomer chosen from compounds containing a vinyl group capable of polymerizing, or propagating, a polymerization reaction, and which contains, directly attached to said vinyl group, at least one fluorine atom, one fluoroalkyl group or one fluoroalkoxy group. By way of example of monomer, mention may be made of vinyl fluoride; vinylidene fluoride (VF2); trifluoroethylene (VF3); chlorotrifluoroethylene (CTFE); 1,2-difluoroethylene; tetrafluoroethylene (TFE); hexafluoropropylene (HFP); perfluoro(alkyl vinyl)ethers such as perfluoro(methyl vinyl)ether (PMVE), perfluoro (ethyl vinyl)ether (PEVE) and perfluoro(propyl vinyl)ether (PPVE); perfluoro(1,3-dioxole); perfluoro(2,2-dimethyl-1,3-dioxole) (PDD); the product of formula CF₂═CFOCF₂CF(CF₃)OCF₂CF₂X where X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ where n is 1, 2, 3, 4 or 5; the product of formula R₁CH₂OCF═CF₂ where R₁ is hydrogen or F(CF₂)_{z} and z is 1, 2, 3 or 4; the product of formula R₃OCF═CH₂ where R₃ is F(CF₂)_{z}— and z is 1, 2, 3 or 4; perfluorobutylethylene (PFBE); 3,3,3-trifluoropropene; 2-trifluoromethyl-3,3,3-trifluoro-1-propene. The fluoropolymer may be a homopolymer or a copolymer; it may also include non-fluorinated monomers such as ethylene. In particular, the fluorinated polymer may be chosen from fluorinated ethylene-propylene (FEP), ethylenetetrafluoroethylene (ETFE), polytetrafluoroethyleneperfluoro-propylvinylether (PFA), polytetrafluoroethylene-perfluoromethylvinylether (MFA), polytetrafluoroethylene polyvinylidene fluoride (PVDF), ethylene chlorotrifluoroethylene (ECTFE), polychlorotrifluoroethylene (PCTFE), or a combination thereof. Fluoropolymers allow avoiding contamination possibilities, which can be advantageous for high purity applications. Fluoropolymers also have the advantage of resisting chemicals, in particular acids such as sulfuric acid (H₂SO₄), hydrofluoric acid (HF) or phosphoric (H₃PO₄), which are used, in particular, for the manufacture of semiconductors. It should be noted that, although they are not intended to be in direct contact with the fluid, the nut 60 and the ring 40 may also be made of fluoropolymer.

According to one embodiment, the receiving part 50 may be made of one of the materials chosen from polytetrafluoroethyleneperfluoropropylvinylether (PFA), polytetrafluoroethylene-perfluoromethylvinyl ether (MFA) and polytetrafluoroethylene (PTFE), or a combination thereof.

According to another embodiment, the ring 40 may be made of one of the materials chosen from polyvinylidene fluoride (PVDF), ethylenetetrafluoroethylene (ETFE), ethylenechlorotrifluoroethylene (ECTFE), polychlorotrifluoroethylene (PCTFE), or a combination thereof.

According to another embodiment, the nut 60 may be made of ethylenetetrafluoroethylene (ETFE) or polyvinylidene fluoride (PVDF), or a combination thereof.

According to another embodiment, the body 2 may be made of polytetrafluoroethyleneperfluoro-propylvinylether (PFA) or polytetrafluoroethylene (PTFE), or a combination thereof.

According to another embodiment, the tube 10, 110, 210 may, for example, be made of polytetrafluoroethyleneperfluoro-propylvinylether (PFA), fluorinated ethylene-propylene (FEP), polytetrafluoroethylene-perfluoromethylvinyl ether (MFA), ethylenetetrafluoroethylene (ETFE) or polyvinylidene fluoride (PVDF), or a combination thereof.

According to one embodiment, the receiving part 50 may be made of one of the materials chosen from polytetrafluoroethyleneperfluoropropylvinylether (PFA), polytetrafluoroethylene-perfluoromethylvinyl ether (MFA) and polytetrafluoroethylene (PTFE), or a combination thereof.

According to another embodiment, the ring 40 may be made of one of the materials chosen from polyvinylidene fluoride (PVDF), ethylenetetrafluoroethylene (ETFE), ethylenechlorotrifluoroethylene (ECTFE), polychlorotrifluoroethylene (PCTFE), polytetrafluoroethyleneperfluoropropylvinylether (PFA), polytetrafluoroethylene (PTFE), or a combination thereof.

According to another embodiment, the nut 60 may be made of ethylenetetrafluoroethylene (ETFE) or polyvinylidene fluoride (PVDF), or a combination thereof.

According to another embodiment, the body 2 may be made of polytetrafluoroethyleneperfluoro-propylvinylether (PFA) or polytetrafluoroethylene (PTFE), or a combination thereof.

According to a particular embodiment, the receiving part 50 may thus be made of a material that is more flexible than the body 2, the stiffness of which must be sufficient to ensure a good resistance of its connection by screwing with the nut 60. The receiving part 50 may also be made of a material that is more flexible than the ring 40 (in other words, the receiving part 50 may be made of a material whose Young's modulus is smaller than that of the material forming the ring 40) ensuring a better punching effect during tightening and therefore better sealing.

The connector assembly, according to one embodiment, can be adapted for use in a circuit for transporting toxic and/or corrosive fluids, in particular of the type which can be used in the semiconductor industry, where the sealing requirements are very stringent. Liquid chemicals used in the manufacture of semiconductors are, for example, solvents such as trichloroethylene, acetone, etc., for cleaning or degreasing operations, and acids and/or bases such as sulfuric acid, nitric acid, hydrochloric acid, etc., used to carry out semiconductor attacks or to perform surface preparations and regenerations.

Notably, the use of the nut 60, 160, 760, 860 may provide a simplification of the coupling assembly 1, 701 by eliminating components and increasing ease of assembly. Further, use of the nut 60, 160, 760, 860 may improve assembly forces required, compensate for axial tolerances and correct misalignment between neighboring components and provide noise reduction and vibration decoupling within the coupling assembly 1, 701 by preventing undesired movement between the neighboring components. Further, the nut 60, 160, 760, 860 may be a simple installation and be retrofit, reusable, and cost effective across several possible assemblies of varying complexity as the circumferential split 885 (along with the bridge portion 861C) may allow for the nut 860 to be easily coupled over the connector assembly described herein, while providing the ability to retrofit over existing connector assemblies 1, 701 having tubes of different diameters and sizes and maintaining sealing of the connector assembly. Lastly, the use of the nut 60, 160, 760, may decrease the leakage rate, thereby increasing the lifetime of the coupling assembly 1, 701.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the embodiments as listed below.

Embodiment 1. A nut for a connector assembly for a tube comprising: an annular nut body comprising a polymer and oriented down a central axis, the annular nut body comprising: a circumferential split defining a first circumferential portion and a second circumferential portion, wherein the first circumferential portion and the second circumferential portion are flexibly connected by a pliable bridge portion, wherein the first circumferential portion comprises a first circumferential end and the second circumferential portion comprises a second circumferential end, wherein the first circumferential end and the second circumferential end each comprise a coupling component adapted to fix the first circumferential end and the second circumferential end together.

Embodiment 2. A nut for a connector assembly for a tube comprising: an annular nut body oriented down a central axis, the annular nut body having a cross-section taken along the central axis comprising: an axially projecting portion comprising exterior threadings and an end portion; and a radially projecting portion disposed axially adjacent to the axially projecting portion, wherein the radially projecting portion comprises a first flange projecting radially inward, wherein at least one of the first flange or the end portion is adapted to seal against a neighboring component, and wherein the annular nut body further comprises a circumferential split.

Embodiment 3. A connector assembly for a tube comprising: a body provided with a cavity extending in an axial direction, a ring adapted to be mounted at the periphery of a useful portion of the tube, the ring having at one end a support surface adapted to receive a curved end portion of the tube, and a nut adapted to be screwed onto the body so as to engage the ring to press the curved end portion of the tube against a receiving surface in the axial direction, and an annular receiving part forming the receiving surface and removably mounted on the body, wherein the nut comprises: an annular nut body and oriented down a central axis, the annular nut body having a cross-section taken along the central axis comprising: an axially projecting portion comprising external threadings and an end portion; and a radially projecting portion disposed axially adjacent to the axially projecting portion, wherein at least one of 1) the radially projecting portion comprises a first flange projecting radially inward, wherein at least one of the first flange or the end portion is adapted to seal against receiving part, or 2) wherein the annular nut body comprises a polymer and further comprises a circumferential split.

Embodiment 4. A connector assembly for a tube comprising: a body provided with a cavity extending in an axial direction, an annular receiving part forming a receiving surface and removably mounted on the body, and a nut adapted to be screwed onto the body so as to engage the annular receiving part to press the tube against the receiving surface in the axial direction, wherein the nut comprises: an annular nut body and oriented down a central axis, the annular nut body having a cross-section taken along the central axis comprising: an axially projecting portion comprising external threadings and an end portion; and a radially projecting portion disposed axially adjacent to the axially projecting portion, wherein at least one of 1) the radially projecting portion comprises a first flange projecting radially inward, wherein at least one of the first flange or the end portion is adapted to seal against receiving part, or 2) wherein the annular nut body comprises a polymer and further comprises a circumferential split.

Embodiment 5. The nut or connector assembly according to any of embodiments 2-4, wherein the axially projecting portion comprises a second flange projecting radially outward, wherein the second flange comprises an axially oriented tab is disposed radially and adapted to lock the nut against a neighboring component.

Embodiment 6. The nut or connector assembly according to embodiment 5, wherein the axially oriented tab has a rectilinear cross-section.

Embodiment 7. The nut or connector assembly according to embodiment 5, wherein the axially oriented tab has a length, L_{AOT}, and the axially projecting portion has a length, L_{APP}, and wherein L_{APP}>L_{AOT}, such as L_{APP}>1.5 L_{AOT}, such as L_{APP}>2 L_{AOT}, such as L_{APP}>3 L_{AOT}, or such as L_{APP}>5 L_{AOT}.

Embodiment 8. The nut or connector assembly according to embodiment 5, wherein the axially oriented tab comprises a bridge portion and a head portion.

Embodiment 9. The nut or connector assembly according to embodiment 8, wherein the bridge portion has a width, W_{BP}, and the head portion has a width, W_{HP}, and wherein W_{HP}>W_{BP}, such as W_{HP}>1.5 W_{BP}, such as W_{HP}>2 W_{BP}, such as W_{HP}>3 W_{BP}, or such as W_{HP}>5 W_{BP}.

Embodiment 10. The nut or connector assembly according to embodiment 5, wherein the second flange has a width, W_{SF}, that varies around a circumference of the annular nut body.

Embodiment 11. The nut or connector assembly according to embodiment 5, wherein the first flange has a width, W_{FF}, and the second flange has a width, W_{SF}, and wherein W_{SF}>W_{FF}, such as W_{SF}>1.5 W_{FF}, such as W_{SF}>2 W_{FF}, such as W_{SF}>3 W_{FF}, or such as W_{SF}>5 W_{FF}.

Embodiment 12. The nut or connector assembly according to any of embodiments 2-4, wherein the first flange has an arcuate cross-section.

Embodiment 13. The nut or connector assembly according to any of embodiments 2-4, wherein the annular nut body comprises a pliable bridge portion flexibly connecting a first circumferential portion and a second circumferential portion.

Embodiment 14. The nut or connector assembly according to any of embodiments 1-4, wherein the nut comprises a polymer comprising at least one of polytetrafluoroethyleneperfluoropropylvinylether (PFA), polytetrafluoroethylene-perfluoromethylvinyl ether (MFA), polytetrafluoroethylene (PTFE), fluorinated ethylene-propylene (FEP), ethylenetetrafluoroethylene (ETFE), polytetrafluoroethyleneperfluoro-propylvinylether (PFA), polytetrafluoroethylene-perfluoromethylvinylether (MFA), polytetrafluoroethylene polyvinylidene fluoride (PVDF), ethylene chlorotrifluoroethylene (ECTFE), polychlorotrifluoroethylene (PCTFE), or a combination thereof.

Embodiment 15. The nut according to embodiment 1, wherein the coupling component of at least one of the first circumferential end and the second circumferential end comprises at least one of nuts, bolts, bearings, battens, buckles, clips, flanges, frogs, grommets, hook-and-eyes, latches, pegs, nails, rivets, tongue-and grooves, screw anchors, snap fasteners, stitches, threaded fasteners, ties, toggle bolts, wedges anchors, screws, bolts, clamps, clasps, clips, latches, pins, rivets, ties, or nails.

Embodiment 16. The connector assembly according to any of embodiments 3-4, wherein there is a seal between the body and the receiving part.

Embodiment 17. The connector assembly according to embodiment 16, wherein the seal comprises a male element and a female element.

Embodiment 18. The connector assembly according to any of embodiments 3-4, wherein the cavity of the body comprises a main section and an enlarged end section opening outwards, wherein the body comprises a shoulder at the junction between the main section and the end section, and wherein the receiving part is mounted inside the body against the shoulder.

Embodiment 19. The connector assembly according to embodiment 18, wherein the receiving part has a useful internal surface configured to connect the main section of the cavity and the useful portion of the tube.

Embodiment 20. The connector assembly according to embodiment 18, wherein the useful internal surface of the receiving part is cylindrical with a diameter substantially equal to the internal diameter of the main section.

Embodiment 21. The connector assembly according to embodiment 18, wherein the useful internal surface of the receiving part is frustoconical.

Embodiment 22. The connector assembly according to any of embodiments 3-4, wherein the body and the receiving part lock the receiving part relative to the body in the radial direction.

Embodiment 23. The connector assembly according to embodiment 3, wherein the nut is mounted at the periphery of the ring.

Embodiment 24. The connector assembly according to embodiment 3, wherein the ring comprises a rib.

Embodiment 25. The connector assembly according to any of embodiments 3-4, wherein the nut is configured to be screwed into the cavity of the body.

Embodiment 26. The connector assembly according to embodiment 3, wherein the receiving part has an annular groove.

Embodiment 27. The connector assembly according to embodiment 3, wherein the tube comprises an end portion which is curved against the support surface of the ring.

Embodiment 28. The connector assembly according to embodiment 27, wherein the support surface of the ring contacts only a portion of the end portion of the tube.

Embodiment 29. The connector assembly according to embodiment 28, wherein the support surface of the ring comprises a beveled surface.

Embodiment 30. The connector assembly according to any of embodiments 3-4, wherein the body is a pump, a valve, a manifold, a fitting, or a stopper.

Embodiment 31. The connector assembly according to any of embodiments 3-4, wherein the nut provides a leakage rate of as between 100-500 cc/min via the sealing of at least one of the first flange or the end portion against receiving part.

Embodiment 32. The connector assembly according to embodiment 3, wherein the circumferential split is parallel to the central axis.

Embodiment 33. The connector assembly according to embodiment 3, wherein the circumferential split is diagonal along the central axis.

Embodiment 34. The connector assembly according to embodiment 3, wherein the circumferential split is zig-zag shape along the central axis.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, however, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A nut for a connector assembly for a tube comprising:
an annular nut body comprising a polymer and oriented down a central axis, the annular nut body comprising:
a circumferential split defining a first circumferential portion and a second circumferential portion, wherein the first circumferential portion and the second circumferential portion are flexibly connected by a pliable bridge portion, wherein the first circumferential portion comprises a first circumferential end and the second circumferential portion comprises a second circumferential end, wherein the first circumferential end and the second circumferential end each comprise a coupling component adapted to fix the first circumferential end and the second circumferential end together.

2. A nut for a connector assembly for a tube comprising:
an annular nut body oriented down a central axis, the annular nut body having a cross-section taken along the central axis comprising:
an axially projecting portion comprising exterior threadings and an end portion; and
a radially projecting portion disposed axially adjacent to the axially projecting portion, wherein the radially projecting portion comprises a first flange projecting radially inward, wherein at least one of the first flange or the end portion is adapted to seal against a neighboring component, and wherein the annular nut body further comprises a circumferential split.

3. A connector assembly for a tube comprising:
a body provided with a cavity extending in an axial direction,
a ring adapted to be mounted at the periphery of a useful portion of the tube, the ring having at one end a support surface adapted to receive a curved end portion of the tube, and
a nut adapted to be screwed onto the body so as to engage the ring to press the curved end portion of the tube against a receiving surface in the axial direction, and an annular receiving part forming the receiving surface and removably mounted on the body, wherein the nut comprises:
an annular nut body and oriented down a central axis, the annular nut body having a cross-section taken along the central axis comprising:
an axially projecting portion comprising external threadings and an end portion; and
a radially projecting portion disposed axially adjacent to the axially projecting portion, wherein at least one of 1) the radially projecting portion comprises a
first flange projecting radially inward, wherein at least one of the first flange or the end portion is adapted to seal against receiving part, or 2) wherein the annular nut body comprises a polymer and further comprises a circumferential split.

4. The nut according to claim 2, wherein the axially projecting portion comprises a second flange projecting radially outward, wherein the second flange comprises an axially oriented tab is disposed radially and adapted to lock the nut against a neighboring component.

5. The nut according to claim 1, wherein the axially oriented tab has a rectilinear cross-section.

6. The nut according to claim 4, wherein the axially oriented tab comprises a bridge portion and a head portion.

7. The nut according to claim 4, wherein the second flange has a width, W_{SF}, that varies around a circumference of the annular nut body.

8. The nut according to claim 2, wherein the first flange has an arcuate cross-section.

9. The nut according to claim 2, wherein the annular nut body comprises a pliable bridge portion flexibly connecting a first circumferential portion and a second circumferential portion.

10. The connector assembly according to claim 3, wherein there is a seal between the body and the receiving part.

11. The connector assembly according to claim 10, wherein the seal comprises a male element and a female element.

12. The connector assembly according to claim 3, wherein the cavity of the body comprises a main section and an enlarged end section opening outwards, wherein the body comprises a shoulder at the junction between the main section and the end section, and wherein the receiving part is mounted inside the body against the shoulder.

13. The connector assembly according to claim 12, wherein the receiving part has a useful internal surface configured to connect the main section of the cavity and the useful portion of the tube.

14. The connector assembly according to claim 3, wherein the body and the receiving part lock the receiving part relative to the body in the radial direction.

15. The connector assembly according to claim 3, wherein the nut is mounted at the periphery of the ring.

16. The connector assembly according to claim 3, wherein the ring comprises a rib.

17. The connector assembly according to claim 3, wherein the nut is configured to be screwed into the cavity of the body.

18. The connector assembly according to claim 3, wherein the receiving part has an annular groove.

19. The connector assembly according to claim 3, wherein the tube comprises an end portion which is curved against the support surface of the ring.

20. The connector assembly according to claim 19, wherein the support surface of the ring contacts only a portion of the end portion of the tube.
